(19) United States
(12) Patent Application Publication
(10) Pub. No.: US 2025/0156751 A1
(43) Pub. Date: May 15, 2025

(54) REAL-TIME PERSONALIZED RECOMMENDATIONS BY AN ULTRAFAST, LIGHTWEIGHT, HIGHLY PERFORMANT SYSTEM

(71) Applicant: Adobe Inc., San Jose, CA (US)

(72) Inventors: Nikolaos VLASSIS, San Jose, CA (US); Oliver BRDICZKA, San Jose, CA (US); Nipun JINDAL, Delhi (IN); Marcos Berteli SLOMP, Seattle, WA (US); Kevin John WAMPLER, Seattle, WA (US); Anand KHANNA, San Jose, CA (US); Amine Ben KHALIFA, Sunnyvale, CA (US)

(21) Appl. No.: 18/509,004

(22) Filed: Nov. 14, 2023

(51) Int. Cl. G06N 20/00

(52) U.S. Cl. CPC G06N 20/00

(57) ABSTRACT

Users interact with items, such as movies, music, and document templates, among others. Item recommendations based on these user interactions are determined and provided to a user. A binary matrix indicating what items users have interacted with is provided. A design matrix is determined from the binary matrix. In this format, the model can be processed in parallel by a computing device. Columns of the design matrix are processed by threads of one or more CPUs of a computing system, in which a least squares analysis is performed over each thread. The output of the processing is a trained model useable for outputting an item recommendation responsive to an input user interaction during inference.

### BACKGROUND

Item recommendation refers to the process of suggesting items to users based on various factors, including their past behavior, preferences, or interactions with a system. This is commonly found in applications like online shopping platforms, movie streaming services, music streaming apps, and document management systems.

### SUMMARY

At a high level, the technology relates to determining recommendations for items, such as movies, music, documents, templates, and so forth. The item recommendations are determined using a model that takes substantially fewer computational resources to train and execute than prior models.

This is due in part to learning from user interactions provided as a binary matrix indicating only whether a user has interacted with certain items previously. The binary matrix includes dimensions of user identifiers corresponding to user and item identifiers corresponding to items. A binary indication comprised within the matrix identifies whether a user corresponding to a user identifier has interacted with an item corresponding to an item identifier.

The binary matrix is converted to a design matrix. This can be done by taking the binary matrix transposed and multiplying it by the binary matrix. During a training process, the design matrix is then processed in parallel by central processing units of a computing device that access to a shared memory where the design matrix is stored. For instance, each thread processed by the central processing units (CPUs) may correspond to one column of the design matrix. The CPUs perform a least squares analysis when processing each thread, for instance, by using greedy coordinate descent. In doing so, a greedy coordinate descent algorithm uses a highest absolute value to choose in each iteration the most “promising” dimension to update. In an example, 20 iterations of greedy coordinate descent may be done per thread during training. That is, a coordinate that maximizes a gradient vector id determined in each iteration, and only that coordinate is updated.

The output of the training is a trained model having weights. These weights can act as coefficients when applied to a user interaction at inference to determine an item recommendation. In doing so, the coefficients may be summed for each item as identified by its respective item identifier. An item identifier having the highest item score is selected, and an item recommendation is provided corresponding to the selected item identifier with the highest score.

In some aspects, the popularity of an item may be artificially inflated due to an event, such as users utilizing an abnormally high number of Halloween document templates in the days leading up to Halloween. The popularity can be compensated for by determining the number of interactions an item has during a time period, such as a day, and using the popularity to adjust the weight of a particular coefficient by multiplying it by the inverse popularity (e.g., the inverse number of interactions). This will adjust the model's bias away from the artificially inflated data.

The trained model can be used to determine an item recommendation. The trained model, e.g., the weights or adjusted weights contained therein, may be used to determine the item recommendation from an input item interaction by a user. The item recommendation, once determined, is provided to a user.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which an example item recommendation engine is deployed, in accordance with an aspect described herein;

FIG. 2 illustrates an operation performed by components of the item recommendation engine of FIG. 1, whereby a design matrix is determined from a binary matrix, in accordance with an aspect described herein;

FIG. 3 illustrates an example parallel processing of the design matrix of FIG. 2, in accordance with an aspect described herein;

FIG. 4 illustrates an example popularity adjustment performed by components of the item recommendation engine of FIG. 1, in accordance with an aspect described herein;

FIG. 5 illustrates a block diagram with an example method for providing item recommendations using the item recommendation engine of FIG. 1, in accordance with an aspect described herein; and

FIG. 6 illustrates an example computing device suitable for implementing aspects of the technology, in accordance with an aspect described herein.

### DETAILED DESCRIPTION

The problem of personalized recommendations is ubiquitous in the industry. In general, the problem involves choosing from a set of candidate items an item that is most relevant for a given user. Given a desired notion of “relevance,” the main technical challenge is how to optimize the recommendation policy given an observed dataset of user-item interactions. That is, one the main challenges is how to design a process that can be implemented quickly and efficiently by machines in real time, given the number of potential candidate item recommendations and sparse datasets.

Aspects of the present technology improve upon a version of the problem, known in the literature as collaborative filtering (CF). In CF, a universal set of items is provided from which an item can be chosen. It is assumed that all historical information about a user is captured in a “bag-of-items”: those are all the items the user has interacted with, at least once, in the past. An item may be any piece of information that can be recommended to a user following the user's interaction with another item, or piece of information. Some examples include document templates, movies, music, and so forth.

One conventional CF algorithm follows the auto-regressive pattern: For each item in a bag-of-items of a user, it tries to predict that item from the rest of the items in the bag. Mathematically, if a multi-hot vector (e.g., a vector of 0's and 1's) is used for each observed bag-of-items, and the vectors are put in the rows of a matrix A, the auto-regressive objective is a collection of linear least-squares (LS) problems:

$$\begin{matrix}{min}_{w} {‖ A - AW ‖}_{F}^{2} + λ {‖ W ‖}_{F}^{2} \\ s . t . diag ( W ) = 0\end{matrix} .$$

The zero-diagonal constraint is used to prevent the trivial solution of W being the identity matrix. The above optimization problem can solve the enclosed form using a matrix inversion. However, matrix inversion does not scale very well to large numbers of items and is processed slowly by a computing device because theoretically there are limits to how fast it can be done (either by serial of parallel processing); it takes time almost cubic in the dimension of the matrix. As will be descried, the present technology improves upon this because it introduces a sub-quadratic method for solving the optimization problem, allowing the problem to be solved by more efficient computational processes.

Improving upon the conventional methodologies, the above optimization problem can be decoupled into a set of independent least squares problems, one for each column of A, by dropping the zero-diagonal constraint. Each of the least squares problems shares almost the same design matrix (the product of A transposed with itself), which allows for a more efficient memory handling over conventional methods, as will be explained.

One technical improvement is a very efficient, multithreaded implementation of the above algorithm for multi-core CPU machines. The full design matrix can be allocated in shared memory (memory that is directly accessible by each thread), and then have each thread solve several constrained least squares problems. The zero-diagonal constraint of the original optimization problem is now enforced simply by having each local least squares solver ignoring the column of the shared design matrix that corresponds to the index of that least squares problem. This implementation takes full advantage of modern CPU architectures and modern software libraries, and provides for CPU processing techniques not usable with conventional methods.

Moreover, the above optimization problem can be regularized with an L2 constraint, and it is empirically demonstrated that in practice the optimal regularization coefficient λ is large. This means that, in the decoupled version, the objective function of each local least squares problem is strongly convex.

Instead, the technology described herein can solve all local least squares problems in each thread approximately, using greedy coordinate descent. This method fits well with the multithreaded implementation. Here, for each local least squares problem, in each iteration the coordinate that maximizes (in absolute value) the gradient vector is identified, and only that coordinate is updated. The update mechanism can naturally exploit sparsity of the design matrix. After a relatively small number of iterations (between 10 and 50 for example), solutions that are nearly optimal (as compared to the solutions obtained by conventional methods) emerge, but only at a fraction of the time compared to known methods. Additionally, the trained model is sparse, which allows for particularly fast inference (which is essentially a multiplication of a sparse vector with a sparse matrix).

Conventionally, recommendation models are typically evaluated based on a standard training/test-set split protocol. The present technology further provides for a novel evaluation protocol that tries to mimic the way the recommender is being used in production. Namely, a progressive loss-style protocol is followed, in which the item recommendation engine is trained offline from data obtained over a given period, and then the model is tested on the next-day data or data of another desired time period. However, a challenge with offline evaluation is that the data used for estimation are typically biased; this can happen, for example, when some algorithm (or a human moderator) differentially promotes certain items on a user interface, and specifics of this protocol are lacking (or there are unobserved events).

To address those issues, the described evaluation scheme approximates the causal effect of recommending each item to a user. To achieve this, a daily popularity (or another desired time frame) of an item can be used as a proxy of the average propensity of this item is promoted to a user. This assumption is supported by theoretical results that suggest that a time-average of (deterministic) propensities converges to the right stochastic item propensity. The reciprocal of the daily popularity is then used as a proxy of the inverse propensity of the item, which in turn is used to weigh metrics of interest. Using this approach, the estimation bias of offline evaluation methods that does not attempt any correction and is prone to popularity drifts is significantly reduced. This, in turn, allows better calibration of the recommendation policies offline, making them more effective in predicting next-day user choices, and hence improving the overall metrics.

It will be realized that the method previously described is only an example that can be practiced from the description that follows, and it is provided to more easily understand the technology and recognize its benefits. Additional examples are now described with reference to the figures.

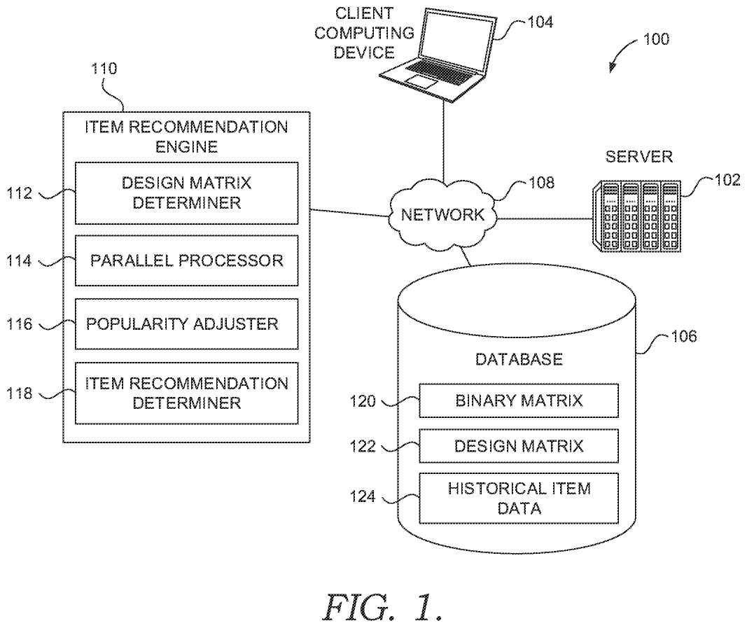

With reference now to FIG. 1, an example operating environment 100 in which aspects of the technology may be employed is provided. Among other components or engines not shown, operating environment 100 comprises server 102, computing device 104, and database 106, which are communicating via network 108.

Each is in communication with item recommendation engine 110, which is generally used to recommend an item in response to item interactions by a user. In general, an item interaction is broadly any engagement with an item. For instance, in the context of document templates as items, a user may open, load, edit, save, and so forth a document template, thereby interacting with the document template item. In the context of music as items, a user may download, stream, input a sentiment, and so on, thereby interacting with the music item. In the context of a movie, a user may watch, input a sentiment, select a summary, watch a trailer, and so on, thereby interacting the movie item. It will be realized that this encompasses other interactions with items beyond the examples described, and which are generally relevant to the context of a particular item.

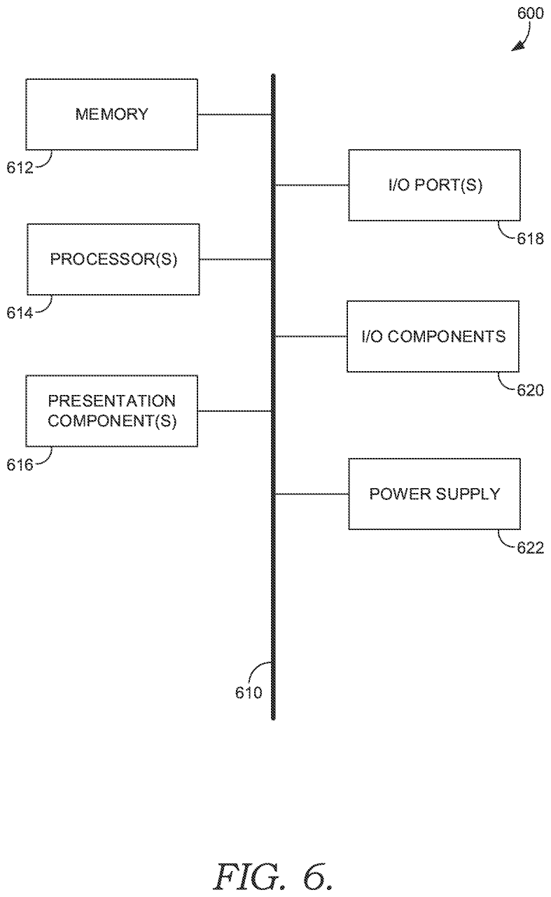

Database 106 generally stores information, including data, computer instructions (e.g., software program instructions, routines, or services), or models used in embodiments of the described technologies. Although depicted as a single database component, database 106 may be embodied as one or more databases or may be in the cloud. In aspects, database 106 is representative of a distributed ledger network. For instance, database 106 may store executable code for functions performed by item recommendation engine 110. Database 106 may store data used by item recommendation engine 110 in determining item recommendations, such as binary matrix 120, design matrix 122, historical item data 124, which will be further described. Database 106 may be any form of memory, such as memory 612 described with respect to FIG. 6. In a specific example, database 106 is a shared cache memory accessible by one or more CPUs of server 102 or computing device 104, such that CPUs may parallel-process data, such as binary matrix 120 or design matrix 122 stored permanently or temporarily within database 106. It will be understood that a shared memory may comprise one or more memory hardware components in any local or distributed architecture.

Network 108 may include one or more networks (e.g., public network or virtual private network [VPN]), as shown with network 108. Network 108 may include, without limitation, one or more local area networks (LANs), wide area networks (WANs), or any other communication network or method.

Generally, server 102 is a computing device that implements functional aspects of operating environment 100, such as one or more functions of item recommendation engine 110 to facilitate item recommendation. One suitable example of a computing device that can be employed as server 102 is described as computing device 600 with respect to FIG. 6. In implementations, server 102 represents a backend or server-side device.

Computing device 104 is generally a computing device that may be used to interact with items and receive item recommendations from item recommendation engine 110. As with other components of FIG. 1, computing device 104 is intended to represent one or more computing devices. One suitable example of a computing device that can be employed as computing device 104 is described as computing device 600 with respect to FIG. 6. In implementations, computing device 104 is a client-side or front-end device. In addition to server 102, computing device 104 may implement functional aspects of operating environment 100, such as one or more functions of item recommendation engine 110. It will be understood that some implementations of the technology will comprise either a client-side or front-end computing device, a backend or server-side computing device, or both executing any combination of functions from item recommendation engine 110, among other functions. Any combination of one or more functions of item recommendation engine 110 may be performed by computing device 104, server 102, or other components not illustrated in this example.

To provide item recommendations, item recommendation engine 110 employs design matrix determiner 112, parallel processor 114, popularity adjuster 116, and item recommendation determiner 118. An item recommendation is a predicted item that is determined based on a user's, or other user's, past item interactions, and includes an item with which the user may interact.

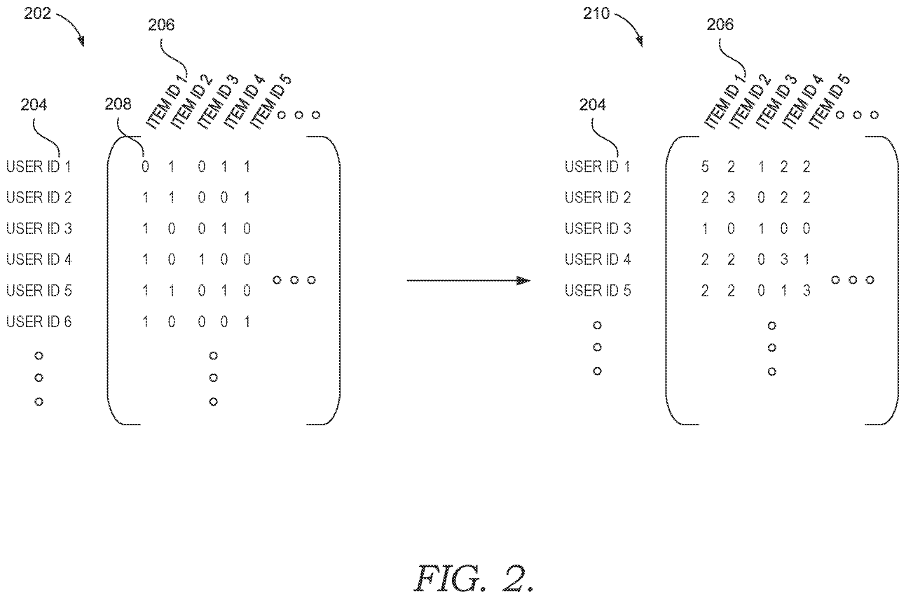

Design matrix determiner 112 generally determines a design matrix from a binary matrix. An example illustration is provided in FIG. 2. Here, design matrix 210 is being determined from binary matrix 202. In this example, binary matrix 202 comprises user identifiers, such as user identifier 204; item identifiers such as item identifier 206; and indications, such as indication 208. In general, the user identifiers correspond to users and may uniquely identify a user, while the item identifiers correspond to items and may uniquely identify an item. In aspects, the indications are binary indications, such as having 1 or 0 represent whether a user has interacted with an item in the past. In this example, 1 represents that a user, as represented by a user identifier, has interacted with an item, represented by the item identifier, at some point in the past, while 0 may be used to indicate that the user has not previously interacted with the item. In the example provided by binary matrix 202 and design matrix 210, the ellipses are used to indicate that any matrix dimensions may be possible.

Design matrix determiner 112 generally determines design matrix 210 from binary matrix 202. To do so, the binary matrix, which can be represented as A, is transposed and multiplied by binary matrix 202, A. The resulting matrix is the design matrix, in this case, illustrated as design matrix 210.

Binary matrices and design matrices may be stored in a shared memory. Database 106 comprises binary matrix 120 and design matrix 122. For instance, binary matrix 202 may be stored as binary matrix 120, while design matrix 210 may be stored as design matrix 122. Each is accessible by components of item recommendation engine 110. Further, CPUs of server 102 or computing device 104 may access binary matrix 120 or design matrix 122 in the shared memory to perform operations on the data.

Referring back to FIG. 1, parallel processor 114 can be employed to train a model using design matrix 122. That is, parallel processor 114 may instruct one or more CPUs of server 102 or computing device 104 to execute an operation across multiple threads, each thread performing a least squares analysis over a column within the design matrix 122, thus attempting to predict the design matrix 122 from itself during training. The threads are executed in parallel, which is an advantage of the present technology over prior conventional methods.

As noted, conventional methods are limited in ability to parallelize the computational process. The design of the presently described processes allows for parallel computation by the computer, thus providing a different way to use the computer's technical functionality to solve problems, e.g., it changes the computational processing scheme of the computer relative to existing methods using features of how the processor operates to more efficiently and in a more timely manner train the algorithm to determine the best item recommendation. By parallel processing, each column can be treated individually as its own least squares analysis, and this is what aids in increasing scale, where the existing systems would fail.

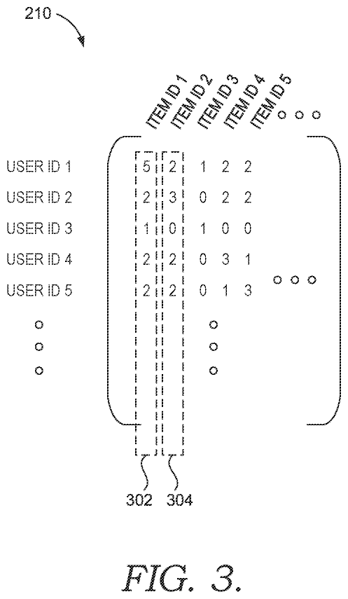

As illustrated in FIG. 3, design matrix 210 is shown as being processed in parallel using parallel processor 114. Here, first thread 302 is used to perform an operation on a column corresponding to item 1, while second thread 304 is being used to simultaneously perform an operation on the column corresponding to item 2. First thread 302 and second thread 304 are processing design matrix 210 in parallel. To train the model, parallel processor 114 may apply greedy coordinate descent. For instance, see Huang Fang, et al., “Efficient Greedy Coordinate Descent via Variable Partitioning,” accepted for the 37th conference on Uncertainty in Artificial Intelligence (UAI 2021), available at https://www.auai.org/uai2021/pdf/uai2021.219.pdf, which is expressly incorporated herein by reference in its entirety. A greedy coordinate descent algorithm may use a highest absolute value to choose in each iteration the most “promising” dimension to update. In an example, 20 iterations of greedy coordinate descent may be done per thread during training.

The process may be repeated for each column of design matrix 210. The output of the parallel processing performed by parallel processor 114 on design matrix 122 is a trained model usable for outputting an item recommendation from an input item interaction. The trained model comprises weights usable as a set of coefficients learned from the training, and which are applied to the input item interaction to determine the item recommendation.

Returning to FIG. 1, popularity adjuster 116 may adjust the trained model, or weights thereof, to adjust for overrepresented data resulting from data biases. This reduces the estimate bias that might occur during the offline training process. To adjust for biases, popularity adjuster 116 determines a popularity of an item—that is, how many interactions an item receives during a given time frame, such as a day, although any time frame may be specified, e.g., day, week, month, quarter, year, or any other provided period of time.

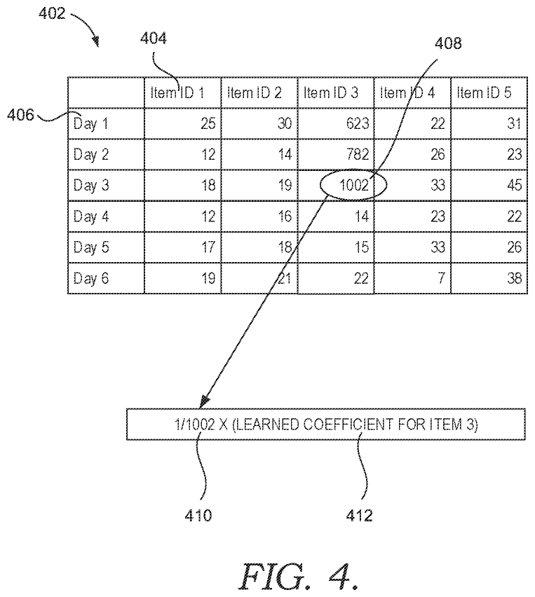

FIG. 4 illustrates an example popularity table 402 that includes the popularity of items relative to periods of time—in this case, certain days. Here, popularity table 402 comprises item identifiers, such as item identifier 404, that corresponds to items, and a period of time, such as time period 406. Popularity table 402 further comprises the number of interactions an item receives by a global population of users during a given period of time, such as interaction count 408. The interaction count during the predefined period of time is a measure of the popularity. Popularity table 402 may be stored as historical item data 124. In aspects, historical item data 124 comprises the historical number of interactions, from which popularity table 402 can be determined.

Popularity adjuster 116 can adjust one or more weights of the trained model, i.e., those that are used as coefficients, based on the popularity of the item. As an example, and also as illustrated in FIG. 4, the inverse of the popularity can be determined by multiplying by the weight, or coefficient, of the model for a given item. For instance, interaction count 408 is associated with item 3 on day 3. Inverse popularity 410 shows the inverse of this popularity. Inverse popularity 410 can be used to proportionally reduce the weight 412 of item 3 (the coefficient for this item learned during training) by multiplying the inverse popularity 410 by the weight 412, thereby adjusting the trained model based on popularity.

Item recommendation determiner 118 generally applies the trained model at inference to determine an item recommendation. The model, as trained by parallel processor 114, may be applied. In an aspect, the trained model as adjusted by popularity adjuster 116 may be applied. For example, the trained model receives an item interaction input for a user, e.g., one received from computing device 104, and it outputs the item recommendation responsive to the input.

To further increase efficiency and speed of the model over existing methods, a subset of coefficients may be determined and applied to an item interaction to determine the item recommendation. For instance, the weights determined using training may be represented as a vector that includes the set of coefficients. In an aspect, the trained model is applied by summing the coefficients for each item as identified by its respective item identifier. An item identifier having the highest item score is selected, and an item recommendation is provided corresponding to the selected item identifier with the highest score.

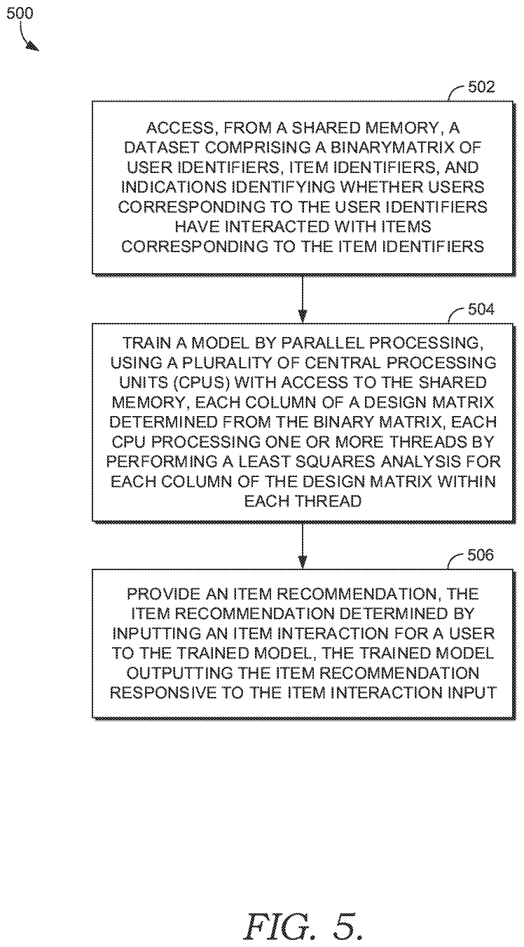

With reference now to FIG. 5, a block diagram is provided respectively illustrating methods 500 for determining and providing an item recommendation. Each block of method 500 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. Method 500 may be implemented in whole or in part by components of operating environment 100.

At block 502, a dataset that comprises a binary matrix is accessed. For instance, this may include recalling binary matrix 120 from database 106. The binary matrix comprises item identifiers that correspond to items and user identifiers that correspond to users, and it further comprises indications as to whether users have interacted with items. These are binary indications, in some aspects.

In aspects, a design matrix is determined from the binary matrix accessed at block 502. This may be done by multiplying the binary matrix by the binary matrix transposed. For instance, this may be done using design matrix determiner 112. The design matrix may be stored in a memory shared by one or more CPUs.

At block 504, a model is trained from the design matrix determined from the binary matrix. The model may be trained using parallel processing. This may be performed by parallel processor 114. Each CPU of a machine, such as server 102 or computing device 104 may be used to process one or more threads during the parallel processing, where each thread is used to perform a least squares analysis on a column of the design matrix. Greedy coordinate descent can be used to process the columns during the least squares analysis. A greedy coordinate descent algorithm may use a highest absolute value to choose in each iteration the most “promising” dimension to update. In an example, at or between 10 and 50 iterations are performed. In an example, 20 iterations of greedy coordinate descent may be done per thread during training. During the greedy coordinate descent process, in each iteration, a coordinate that maximizes a gradient vector is determined. The coordinate corresponding to the maximized gradient vector may be the only coordinate updated. The result of the training is a trained model comprising weights that correspond to a set of coefficients learned during training. The set of coefficients learned from the trained model may be used to determine a vector.

Having described an overview of some embodiments of the present technology, an example computing environment in which embodiments of the present technology may be implemented is described below in order to provide a general context for various aspects of the present technology. Referring now to FIG. 6 in particular, an example operating environment for implementing embodiments of the present technology is shown and designated generally as computing device 600. Computing device 600 is but one example of a suitable computing environment and is not intended to suggest any limitation as to the scope of use or functionality of the technology. Computing device 600 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 6, computing device 600 includes bus 610, which directly or indirectly couples the following devices: memory 612, one or more processors 614, one or more presentation components 616, input/output (I/O) ports 618, input/output components 620, and illustrative power supply 622. Bus 610 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 6 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 600. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 612 includes computer-storage media in the form of volatile or non-volatile memory. The memory may be removable, non-removable, or a combination thereof. Example hardware devices include solid-state memory, hard drives, optical-disc drives, etc. Computing device 600 includes one or more processors that read data from various entities, such as memory 612 or I/O components 620. Presentation component(s) 616 presents data indications to a user or other device. Example presentation components include a display device, speaker, printing component, vibrating component, etc.

I/O ports 618 allow computing device 600 to be logically coupled to other devices, including I/O components 620, some of which may be built-in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 600. Computing device 600 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 600 may be equipped with accelerometers or gyroscopes that enable detection of motion. The output of the accelerometers or gyroscopes may be provided to the display of computing device 600 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, components for determining and providing an item recommendation can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to item recommendation engine 110, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of item recommendation engine 110, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A system comprising:
at least one processor; and
one or more computer storage media storing computer-readable instructions thereon that when executed by the at least one processor cause the at least one processor to perform operations comprising:
accessing, from a shared memory, a dataset comprising a binary matrix of user identifiers, item identifiers, and indications identifying whether users corresponding to the user identifiers have interacted with items corresponding to the item identifiers; and
training a model by parallel processing, using a plurality of central processing units (CPUs) with access to the shared memory, each column of a design matrix determined from the binary matrix, each CPU processing one or more threads by performing a least squares analysis for each column of the design matrix within each thread, the trained model configured to provide an item recommendation from an input item interaction based on the training.

2. The system of claim 1, wherein the least squares analysis is performed by:
determining, in each iteration, a coordinate that maximizes a gradient vector; and
updating only the coordinate corresponding to the maximized gradient vector.

3. The system of claim 1, wherein the design matrix is determined from the product of the binary matrix and a transposed binary matrix.

4. The system of claim 1, wherein a set of coefficients is determined during the training, and wherein the item recommendation is determined from a sum of coefficients for item identifiers corresponding to items with which there has been an interaction.

5. The system of claim 4, wherein the coefficients determine an item score from the sum, and the item recommendation is provided based on the item identifier having the highest item score.

6. The system of claim 1, further comprising identifying a popularity of an item within historical item data based on a number of item interactions over a time period, wherein the item recommendation is based further on the popularity.

7. The system of claim 6, further comprising adjusting weights within the trained model using an inverse of the popularity, wherein the item recommendation is determined from the item interaction using the trained model having the adjusted weights.

8. A method performed by one or more processors, the method comprising:
accessing, from a shared memory, a dataset comprising a binary matrix of user identifiers, item identifiers, and indications identifying whether users corresponding to the user identifiers have interacted with items corresponding to the item identifiers;
training a model comprised by parallel processing each column of a design matrix determined from the binary matrix as a separate thread by one or more central processing units (CPUs) with access to the shared memory, wherein the parallel processing processes a first column within a first thread using a least squares analysis simultaneously with a second column within a second thread using the least squares analysis; and
determining a vector comprising a set of coefficients determined from weights of the trained model, wherein the coefficients of the vector determine an item recommendation from an item interaction.

9. The method of claim 8, wherein the least squares analysis is performed by:
determining, in each iteration, a coordinate that maximizes a gradient vector; and
updating only the coordinate corresponding to the maximized gradient vector.

10. The method of claim 8, wherein the design matrix is determined from the product of the binary matrix and a transposed binary matrix.

11. The method of claim 8, wherein the item recommendation is determined from a sum of the coefficients of the vector for item identifiers corresponding to items with which there has been an interaction.

12. The method of claim 11, wherein the coefficients of the vector determine an item score from the sum, and the item recommendation is provided based on the item identifier having the highest item score.

13. The method of claim 8, further comprising identifying a popularity of an item within historical item data based on a number of item interactions over a time period, wherein the item recommendation is based further on the popularity.

14. The method of claim 13, further comprising adjusting weights within the trained model using an inverse of the popularity, wherein the coefficients applied to the item interaction include the adjusted weights.

15. One or more computer storage media storing computer-readable instructions thereon that, when executed by a processor, cause the processor to perform a method comprising:
accessing, from a shared memory, a dataset comprising a binary matrix of user identifiers, item identifiers, and indications identifying whether users corresponding to the user identifiers have interacted with items corresponding to the item identifiers; and
training a model by parallel processing, using a plurality of central processing units (CPUs) with access to the shared memory, each column of a design matrix determined from the binary matrix, each CPU processing one or more threads by performing a least squares analysis for each column of the design matrix within each thread, the trained model configured to provide an item recommendation from an input item interaction based on the training.

16. The method of claim 15, wherein the least squares analysis is performed by:
determining, in each iteration, a coordinate that maximizes a gradient vector; and
updating only the coordinate corresponding to the maximized gradient vector.

17. The method of claim 15, wherein a set of coefficients is determined during the training, and wherein the item recommendation is determined from a sum of coefficients for item identifiers corresponding to items with which there has been an interaction.

18. The method of claim 17, wherein the coefficients determine an item score from the sum, and the item recommendation is provided based on the item identifier having the highest item score.

19. The method of claim 15, further comprising identifying a popularity of an item within historical item data based on a number of item interactions over a time period, wherein the item recommendation is based further on the popularity.

20. The method of claim 19, further comprising adjusting weights within the trained model using an inverse of the popularity, wherein the item recommendation is determined from the item interaction using the trained model having the adjusted weights.
